(19) United States
(12) Patent Application Publication
(10) Pub. No.: US 2010/0207032 A1
(43) Pub. Date: Aug. 19, 2010

(54) RADIOGRAPHIC IMAGE CAPTURE SYSTEM, RADIATION GENERATION DEVICE, IMAGE CAPTURE CONTROL DEVICE AND RADIOGRAPHIC IMAGE CAPTURE DEVICE

(75) Inventors: Keiji TSUBOTA, Kanagawa (JP); Yutaka YOSHIDA, Kanagawa (JP); Kouichi KITANO, Kanagawa (JP); Naoyuki NISHINO, Kanagawa (JP); Yasunori OHTA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Minato-ku, Tokyo (JP)

(21) Appl. No.: 12/706,720

(22) Filed: Feb. 17, 2010

(30) Foreign Application Priority Data
Feb. 18, 2009 (JP) 2009-035379
Feb. 5, 2010 (JP) 2010-024363

(51) Int. Cl. G01T 1/161; G01T 1/24

(52) U.S. Cl. 250/370.09

(57) ABSTRACT

A radiographic image capture system is provided. The system includes: a radiation source control component that, when capturing a radiographic image, controls a radiation source such that radiation for image capture is irradiated after radiation for notification of radiation exposure commencement has been irradiated; a detection component that is provided within an irradiation range of radiation irradiated from the radiation source and that detects radiation irradiated from the radiation source; and a radiographic image capture device that includes: a generation component that has a sensor section with sensitivity to radiation and that generates image information denoting a radiographic image represented by radiation irradiated onto the sensor section, and an image capture control component that, when radiation for notification has been detected by the detection component, controls the generation component such that a radiographic image is captured with the radiation for image capture irradiated after detection.

### CROSS-REFERENCE TO RELATED APPLICATION

This application claims priority under 35 USC 119 from Japanese Patent Applications No. 2009-035379 filed on Feb. 18, 2009 and No. 2010-024363 filed on Feb. 5, 2010, the disclosures of which are incorporated by reference herein.

### BACKGROUND OF THE INVENTION

1. Field of the Invention

The present invention relates to a radiographic image capture system, radiation generation device, image capture control device, and radiographic image capture device.

2. Description of the Related Art

Recently radiation detectors of FPD's (Flat Panel Detectors) and the like that can directly convert radiation into digital data have been put into practice, the FPD's having a radiation sensitive layer disposed on a TFT (Thin Film Transistor) active matrix substrate. Portable radiographic image capture devices (referred to below as “electronic cassettes”) have also recently been put into practice using such radiation detectors housed in a case and capturing radiographic images representing the radiation irradiated thereon.

Since these electronic cassettes are portable, patients (investigation subjects) lying on stretchers or beds can also be imaged, and since the imaging location can be adjusted by changing the position of the electronic cassette, even patients who are unable to move can be flexibly processed.

However, in such FPD's, charge is generated and accumulated in each pixel even in a state in which X-rays are not irradiated, due to dark current and the like. Consequently, a reset operation is performed repeatedly in the electronic cassette during standby, to extract and remove any charge accumulated in each of the pixels of the FPD. If this reset operation is stopped midway then a line aberration is generated in the radiographic image at the position at which the extraction operation of the reset mode was stopped, with a reduction in image quality. Therefore, in order to suppress such a reduction in image quality, when instruction data requesting radiographic image capture is received from an image capture control device performing imaging control (a so-called console), instruction data instructing imaging commencement is transmitted to the console after one frame's worth of the reset operation has been completed. When the console receives the instruction data, X-rays are irradiated onto the electronic cassette from a radiation generation device. Following the transmission of instruction data, the electronic cassette reads out the charge that has accumulated in each of the pixels of the FPD after a specific duration has elapsed. The electronic cassette must wait in this manner until one frame's worth of the reset operation is completed, with this sometimes generating a time lag till commencement of imaging.

As a technique to shorten such a time lag, a technique is described in Japanese Patent Application Laid-Open (JP-A) No. 2005-13272 in which synchronization of the reset operation and X-ray generation timing becomes unnecessary by notifying the drive state (reset operation) of an FPD to the person who is performing the imaging.

Also, in JP-A No. 2006-25832, timing data of the commencement and completion of radiation irradiation is sent by wireless communication from a radiation generation device to an electronic cassette, and the radiation detector reads out the radiographic image based on the timing data. A technique is also described in which the radiation detector reads out a radiographic image when a specific duration has elapsed from receipt of a radiation irradiation commencement signal.

Furthermore, a technique is disclosed in JP-A No. 2008-132216 in which a sensor that detects radiation irradiation is provided to an electronic cassette. In this technique transition is made from the reset operation to a charge accumulation state, in which charge is accumulated in each of the pixels, not only when the electronic cassette has received a control signal for X-ray irradiation commencement, but also when the sensor has detected commencement of irradiation for image capture from a radiation generation device.

However, in the technique of JP-A No. 2005-13272, since the imaging timing is limited and a radiographic image cannot be captured at any desired timing, this sometimes leads to cases when timing synchronization is not achieved and an imaging attempt fails.

In addition, when communication between the electronic cassette and the console is performed by wireless communication, sometimes the communication state becomes unstable and delays in data transmission arise.

Therefore, even though timing data of the commencement and completion of radiation irradiation is sent by wireless communication to an electronic cassette, as in the technique described in JP-A No. 2006-25832, sometimes delays arise in wireless communication, synchronization of timing is not achieved, radiation irradiation cannot be performed when the FPD is in the charge accumulation state, and image capture fails.

In addition, in the technique of JP-A No. 2008-132216, the investigation subject is exposed to unnecessary irradiation during transition to the charge accumulation state of the FPD after the sensor detects the irradiation of radiation for image capture.

### SUMMARY OF THE INVENTION

The present invention is made in consideration of the above circumstances and provides a radiographic image capture system, radiation generation device, image capture control device, and radiographic image capture device that are able to stably capture radiographic images while suppressing radiation exposure to an investigation subject.

A first aspect of the present invention is a radiographic image capture system including: a radiation source control component that, when capturing a radiographic image, controls a radiation source such that radiation for image capture is irradiated after radiation for notification of radiation exposure commencement has been irradiated; a detection component that is provided within an irradiation range of radiation irradiated from the radiation source and that detects radiation irradiated from the radiation source; and a radiographic image capture device. The radiographic image capture device includes: a generation component having a sensor section with sensitivity to radiation and generating image data denoting a radiographic image representing radiation irradiated onto the sensor section; and an image capture control component that, when radiation for notification has been detected, controls the generation component such that a radiographic image is captured with the radiation for image capture irradiated after detection.

A second aspect of the present invention is a radiation generation device including: a radiation source capable of irradiating radiation; and a radiation source control component that, when capturing a radiographic image, controls the radiation source such that radiation for image capture is irradiated after radiation for notification of radiation exposure commencement has been irradiated.

A third aspect of the present invention is an image capture control device including: a radiation source control component that, when capturing a radiographic image, controls a radiation source such that radiation for image capture is irradiated after radiation for notification of radiation exposure commencement has been irradiated.

A fourth aspect of the present invention is a radiographic image capture device including: a generation component that has a sensor section with sensitivity to radiation, the generation component generating image data denoting a radiographic image representing the radiation irradiated onto the sensor section; a detection component, the detection component being provided within an irradiation range of radiation irradiated from a radiation source that irradiates radiation for image capture after radiation for notification of radiation exposure commencement has been irradiated, and the detection component detecting radiation irradiated from the radiation source; and an image capture control component that controls the generation component such that a radiographic image is captured with the radiation for image capture irradiated after detection when the radiation for notification has been detected by the detection component.

### BRIEF DESCRIPTION OF THE DRAWINGS

FIG. 1 is a block diagram showing a configuration of a radiology information system according to an exemplary embodiment.

FIG. 2 is a diagram showing an arrangement of radiographic imaging room in which a radiographic imaging system according to an exemplary embodiment has been disposed.

FIG. 3 is a cut-away perspective view showing the internal configuration of an electronic cassette according to an exemplary embodiment.

FIG. 4 is a block diagram showing a detailed configuration of a radiographic imaging system according to an exemplary embodiment.

FIG. 5 is an equivalent circuit diagram focusing on a single pixel portion of a radiation detector according to an exemplary embodiment.

FIG. 6 is a timing chart showing an operational flow when capturing a radiographic image according to a first exemplary embodiment.

FIG. 7 is a timing chart showing an operational flow when capturing a radiographic image according to a second exemplary embodiment.

### DETAILED DESCRIPTION OF THE INVENTION

A detailed explanation will now be given of embodiments for implementing the present invention, with reference to the drawings.

### First Exemplary Embodiment

Explanation will first be given of the configuration of a Radiology Information System 10 according to an exemplary embodiment.

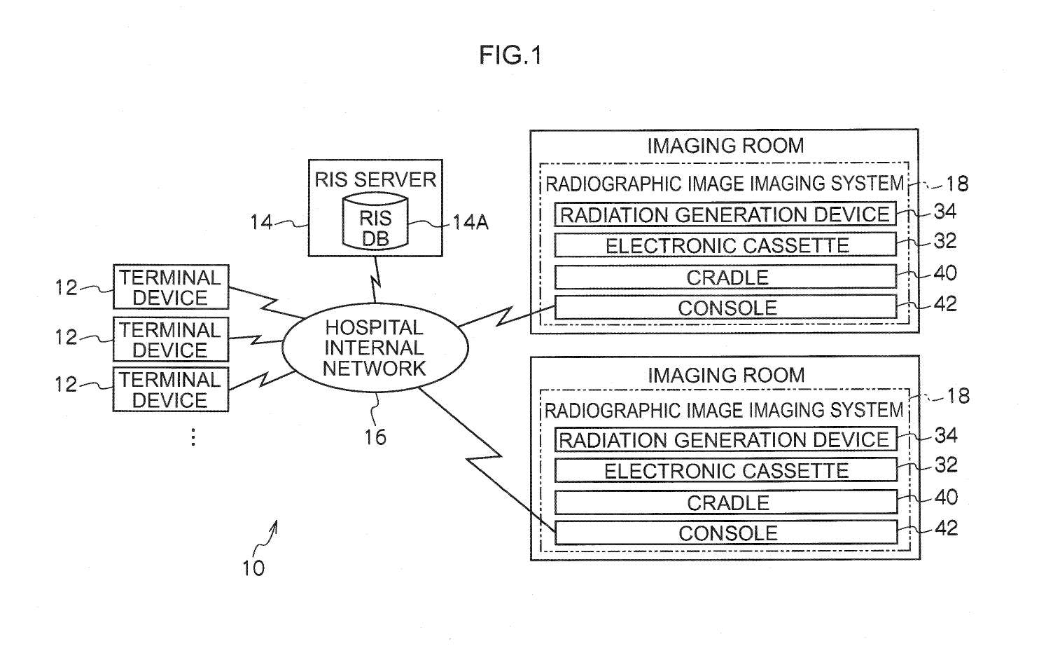

A block diagram is shown in FIG. 1 illustrating main portions of the configuration of the Radiology Information System 10 according to the present exemplary embodiment (referred to below as RIS 10).

The RIS 10 is a systems for performing data management in a radiology department, such as management of consultation appointments, consultation record, and the like. The RIS 10 configures part of an HIS (Hospital Information System).

The RIS 10 is configured with plural imaging request terminal devices 12 (referred to below as terminal devices 12), an RIS server 14, radiographic image imaging systems 18 placed in each individual radiographic imaging room (or operating theater) in the hospital, and a hospital internal network 16, formed from a wired or wireless LAN (Local Area Network) and connecting together each of the radiographic image imaging systems 18. An HIS server that manages the HIS as a whole is connected to the hospital internal network 16.

The terminal devices 12 are for a doctor or radiologist to input and view consultation data and facility reservations, and imaging requests for radiographic images (imaging reservations) are also input via the terminal devices 12. Each of the terminal devices 12 is configured from a PC with monitor, and is connected to the RIS server 14 via the hospital internal network 16 to enable mutual communication therewith.

The RIS server 14 receives imaging requests from each of the terminal devices 12, manages the imaging schedule of radiographic images in the imaging systems 18, and includes an RIS database 14A.

The database 14A is configured with: attribute data of patients (name, gender, date of birth, age, blood group, ID no., and the like); data related to patients, such as illness history, consultation history, previously imaged radiographic images, and the like; data related to the electronic cassettes 32, such as identification number of the electronic cassette 32 of the imaging system 18, format, size, sensitivity, position thereon possible for imaging (contents of imaging requests that can be responded to), date of first use, number of times of use, and the like; and environmental data including the environment for radiographic image capture using the electronic cassette 32, namely the usage environment of the electronic cassette 32 (as an example, the operating theater or imaging room set up specifically for capturing radiographic images).

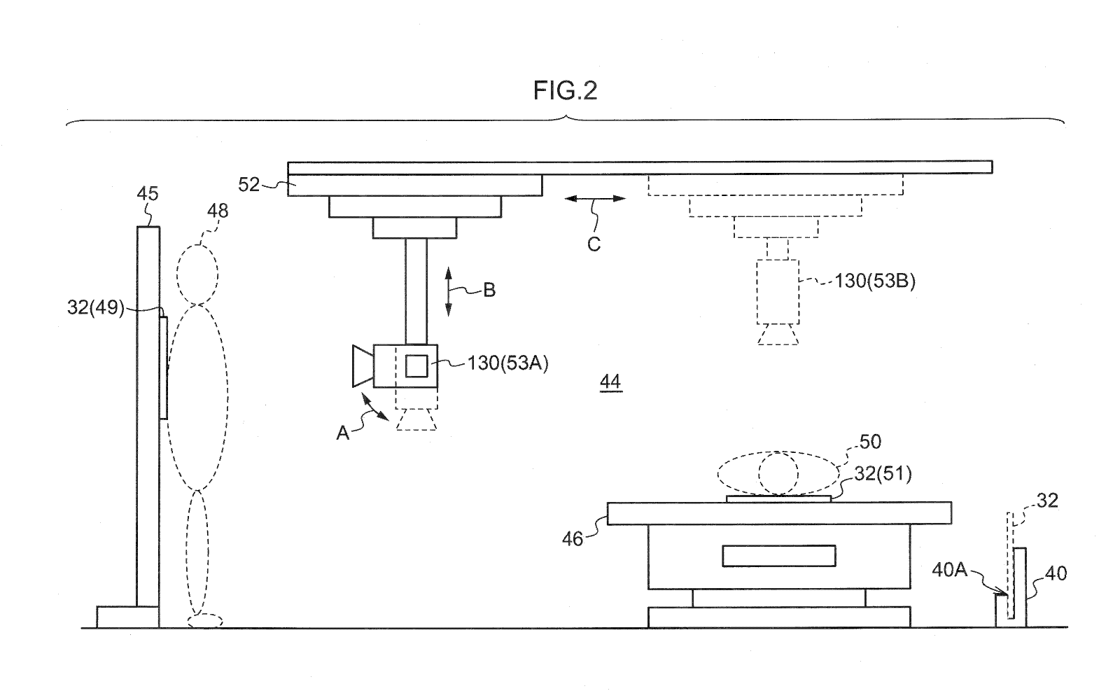

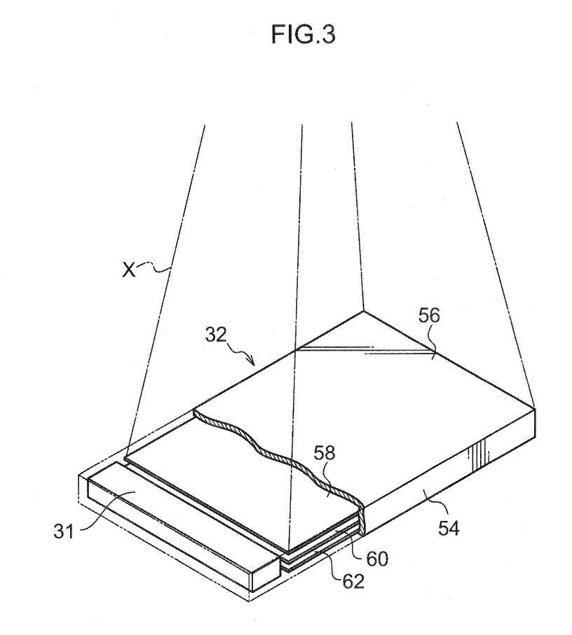

The imaging systems 18 perform imaging of radiographic images under operation of the doctor or radiologist, according to instructions from the RIS server 14. The imaging system 18 is equipped with: an radiation generation device 34 that irradiates X-rays onto an imaging subject from a radiation source 130 (see FIG. 2) with a radiation dose in accordance with radiation exposure conditions; an electronic cassette 32, internally installed with a radiation detector 60 (see FIG. 3) for absorbing X-rays that have passed through the patient, generating charge, and generating image data representing a radiographic image based on the amount of charge generated; a cradle 40 for charging a battery internally housed in the electronic cassette 32; and a console 42 for controlling imaging of radiographic images.

FIG. 2 shows an example of an arrangement of the imaging system 18 according to the present exemplary embodiment disposed in a radiographic imaging room 44.

Within the radiographic imaging room 44 are, as shown in FIG. 2, a rack 45 for holding the electronic cassette 32 upright when capturing a radiographic image in an upright position, and a bed 46, for laying a patient horizontal when capturing a radiographic image in a horizontal position thereon. A space in front of the rack 45 is an imaging position 48 for a patient when capturing a radiographic image in an upright position, and a space above the bed 46 is an imaging position 50 for a patient when capturing a radiographic image in a horizontal position.

A support and movement mechanism 52 is provided in the radiographic imaging room 44 in order to enable radiographic image capture in an upright position and radiographic image capture in a horizontal position with radiation from a single radiation source 130. The support and movement mechanism 52 supports the radiation source 130 so as to be rotatable about a horizontal axis (the direction shown by arrow A in FIG. 2), movable in a vertical direction (the direction shown by arrow B in FIG. 2), and also movable in a horizontal direction (the direction shown by arrow C in FIG. 2). The support and movement mechanism 52 is equipped with a drive source for rotating the radiation source 130 about a horizontal axis, a drive source for moving the radiation source 130 in a vertical direction, and a drive source for moving the radiation source 130 in a horizontal direction.

The cradle 40 is configured with an accommodation portion 40A capable of accommodating the electronic cassette 32.

The electronic cassette 32 is accommodated in the cradle 40 when on standby and charging of an internally housed battery is performed, and the electronic cassette 32 is taken out from the cradle 40 by a radiologist when capturing a radiographic image. When the imaging orientation is upright the electronic cassette 32 is moved to, and positioned in, a hold position 49 on the rack 45, and when the imaging orientation is horizontal the electronic cassette 32 is moved to, and positioned in, a position 51 above the bed 46.

In the radiographic image imaging system 18 of the present exemplary embodiment, the radiation generation device 34 and the console 42 are each connected together with cables, and transmit and receive various data by wired communication, however the cables connecting the devices are omitted in FIG. 2. Various data is transmitted and received between the electronic cassette 32 and the radiographic imaging room 44 by wireless communication.

The electronic cassette 32 is not limited to use within the radiographic imaging room 44, and, for example, can be employed during medical examinations and rounds in a hospital.

FIG. 3 shows the internal configuration of the electronic cassette 32 according to the present exemplary embodiment.

As shown in FIG. 3, the electronic cassette 32 is equipped with a case 54, made from a material through which X-rays can pass and configuring a waterproof, tightly sealed structure. There is a chance that the electronic cassette 32 will get adhered to by blood fluids and germs during use in an operating theater or the like. Since the electronic cassette 32 is of a waterproof, tightly sealed structure, each single electronic cassette 32 can be reused repeatedly by sterilization and cleaning as required.

Disposed within the case 54, in sequence from an irradiation face 56 side of the case 54 onto which X-rays are irradiated, are: a grid 58 that removes X-rays scattered by the patient; a radiation detector 60 that detects X-rays that have passed through the patient; and a lead plate 62 that absorbs back scattered X-rays. Note that the irradiation face 56 of the case 54 may also be configured as the grid 58.

A case 31 is disposed inside the case 54 at one end, the case 31 housing electrical circuits including a microcomputer and a rechargeable battery that can be recharged. The radiation detector 60 and the electrical circuits are operated by electrical power supplied from the rechargeable battery disposed in the case 31. Preferably a lead plate or the like is disposed on the irradiation face side of the case 31 in order to avoid damage accompanying irradiation of X-rays to the various circuits housed within the case 31.

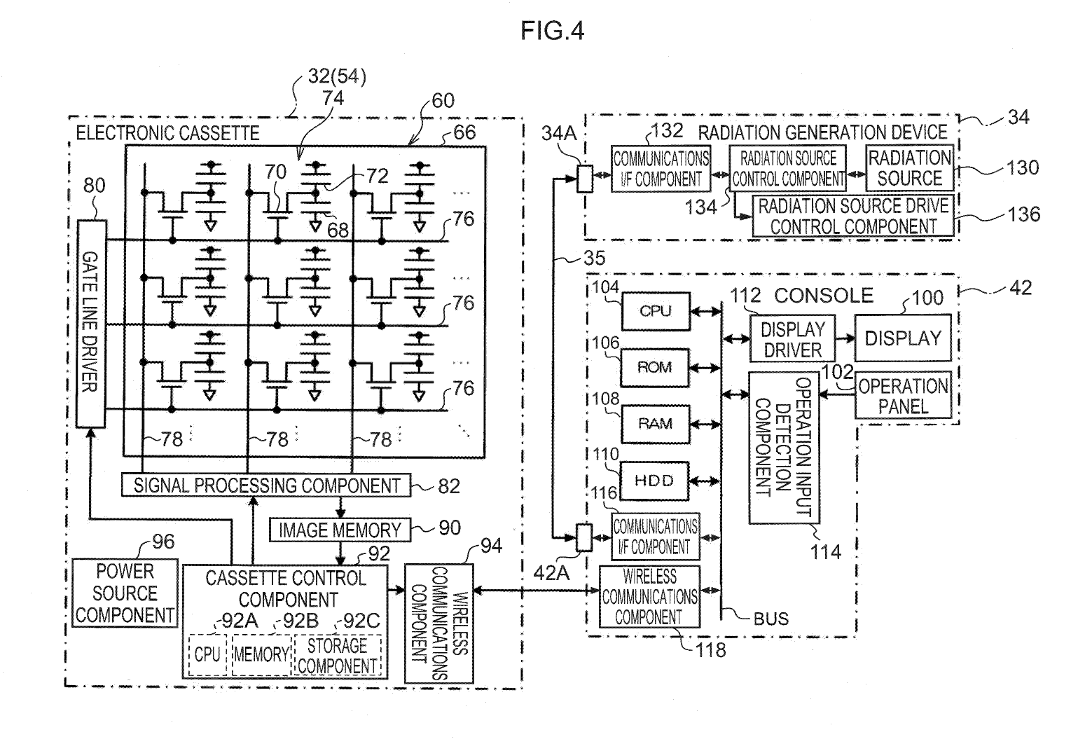

FIG. 4 shows a block diagram with a detailed configuration of the imaging system 18 according to the present exemplary embodiment.

A connection terminal 34A is provided to the radiation generation device 34 for communicating with the console 42. A connection terminal 42A is provided to the console 42 for communicating with the radiation generation device 34. The radiation generation device 34 is connected to the console 42 via a communications cable 35.

The radiation detector 60 internally housed in the electronic cassette 32 is configured with a photoelectric conversion layer layered onto a TFT active matrix substrate 66, the photoelectric conversion layer absorbing X-rays and converting X-rays into charge. The photoelectric conversion layer is formed with, for example, selenium as a main component thereof (for example contained at a proportion of 50% or above) using non-crystalline a-Se (amorphous selenium). When X-rays are irradiated onto the photoelectric conversion layer the photoelectric conversion layer converts irradiated X-rays into charge by internally generating charge (electron-hole pairs) of an amount of electric charge in accordance with the amount of irradiated radiation. It should be noted that indirect conversion into charge may be made in the radiation detector 60 using a fluorescent material and photoelectric conversion element (photodiode), in place of the direct radiation-charge converting materials like amorphous selenium that directly convert X-rays into charge. Gadolinium oxysulfide compounds (GOS) and cesium iodide (CsI) are well known as fluorescent materials. In such cases X-ray-light conversion is performed by the fluorescent material and light-charge conversion is performed using the photodiode photoelectric conversion element.

Plural individual pixel portions 74 are disposed in a matrix shape on the TFT active matrix substrate 66. Each of the pixel portions 74 is provided with a storage capacitor 68 for accumulating charge generated in the photoelectric conversion layer, and a TFT 70 for reading out the charge accumulated in the storage capacitor 68 (in FIG. 4 an photoelectric conversion layer corresponding to individual pixel portions 74 is shown pictorially as photoelectric conversion portions 72). The charge generated in the photoelectric conversion layer, by irradiation of the electronic cassette 32 with X-rays, is accumulated in the respective storage capacitor 68 of the individual pixel portions 74. In this manner, the image data carried by the X-rays irradiated onto the electronic cassette 32 is converted into charge data, and held in the radiation detector 60.

The TFT active matrix substrate 66 is provided with plural gate lines 76 extending along a fixed direction (row direction) for switching the TFT 70 of the individual pixel portions 74 on and off, and is provided with plural data lines 78 extending in a direction (column direction) perpendicular to the gate lines 76 for reading out accumulated charge from the storage capacitors 68 through the TFT's 70 that are switched on. Individual gate lines 76 are connected to a gate line driver 80, and individual data lines 78 are connected to a signal processing component 82. When charge has accumulated in the storage capacitor 68 of the individual pixel portions 74, the TFT's 70 of the individual pixel portions 74 are switched on in sequence of single row units by a signal supplied from the gate line driver 80 through the gate lines 76, and the charge that has been accumulated in the storage capacitor 68 of the pixel portions 74 for which the TFT 70 is on, is transmitted as an analogue electrical signal through the data lines 78 and input to the signal processing component 82. The charge that has been accumulated in the storage capacitors 68 of individual pixel portions 74 is consequently read out in sequence in single row units.

The signal processing component 82 is operated under the control of a later described cassette control component 92. The signal processing component 82 detects, in single row units, the charge amount that has accumulated in the storage capacitor 68 of the respective pixel portions 74 and outputs digital image data.

An image memory 90 is connected to the signal processing component 82. Image data and error data output from the signal processing component 82 is stored in sequence in the image memory 90. The image memory 90 has a capacity capable of storing image data representing radiographic images from a specific number of frames, and each time one line of charge is read out the one line's worth of image data is stored in sequence in the image memory 90.

The image memory 90 is connected to a cassette control component 92 that controls the overall operation of the electronic cassettes 32. The cassette control component 92 is realized by a microcomputer, and is equipped with a memory 92B including a CPU 92A, ROM, and RAM, and a non-volatile storage component 92C configured from an HDD, flash memory or the like.

A wireless communications component 94 is connected to the cassette control component 92. The wireless communications component 94 conforms to a wireless LAN (Local Area Network) specification, as typified by IEEE (Institute of Electrical and Electronics Engineers) 802.11a/b/g, or the like, and controls transmission of various data to and from external devices by wireless communication. The cassette control component 92 is capable of wireless communication with the console 42 via the wireless communications component 94, and capable of transmitting and receiving various data to and from the console 42. The cassette control component 92 stores radiation exposure conditions, described later, received from the console 42 and commences reading out the charge based on the radiation exposure conditions.

A power source component 96 is provided to the electronic cassette 32, and power supplied from the power source component 96 operates the various circuits and elements described above (the gate line driver 80, the signal processing component 82, the image memory 90, the wireless communications component 94, and the microcomputer functioning as the cassette control component 92). The power source component 96 internally houses a battery (rechargeable battery capable of being recharged) so that the portability of the electronic cassette 32 is not compromised, and power is supplied from the charged battery to various circuits and elements. Note that the lines connecting the various circuits and various elements to the power source component 96 are omitted in FIG. 4.

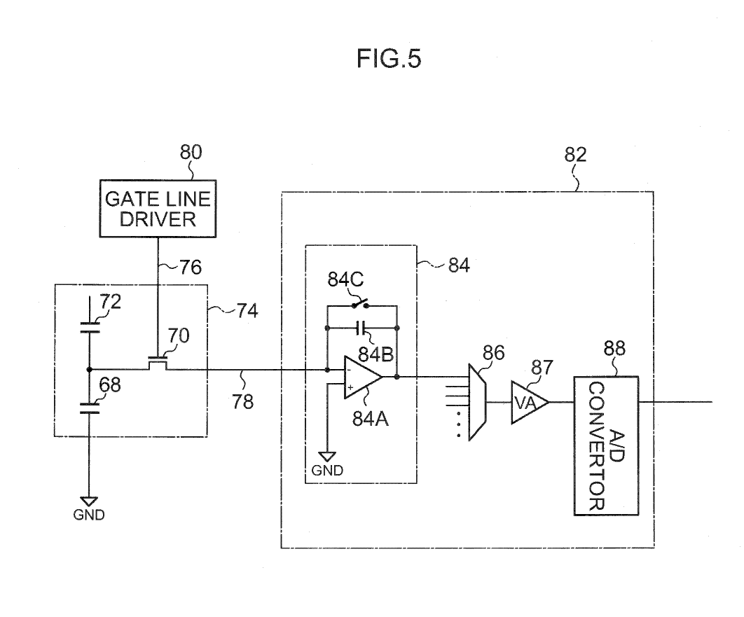

FIG. 5 shows an equivalent circuit diagram focusing on a single pixel portion of the radiation detector 60 according to the present exemplary embodiment.

As shown in FIG. 5, the source of the TFT 70 is connected to the data line 78, and the data line 78 is connected to the signal processing component 82. The drain of the TFT 70 is connected to the storage capacitor 68 and to the photoelectric conversion portion 72, and the gate of the TFT 70 is connected to the gate line 76. The gate line 76 is connected to the gate line driver 80.

The signal processing component 82 is equipped with a sample and hold circuit 84 for each of the individual data lines 78. The electrical signal transmitted through the data line 78 is held in the sample and hold circuit 84. The sample and hold circuit 84 is configured to include an operational amplifier 84A and a condenser 84B, and converts the electrical signal into an analogue voltage. In the sample and hold circuit 84 a switch 84C is provided for shorting both electrodes of the condenser 84B, as a reset circuit to discharge charge accumulated in the condenser 84B.

A multiplexer 86, voltage amplifier 87, and an A/D convertor 88 are connected in sequence to the output side of the sample and hold circuit 84. The electrical signals held in the individual sample and hold circuits are converted into analogue voltages and input in sequence (serially) to the multiplexer 86, and, after the voltage has been amplified in the voltage amplifier 87, are converted into digital image data by the A/D convertor 88.

The console 42 (see FIG. 4) is configured as a server computer, equipped with a display 100 on which an operation menu, captured radiographic images, and the like are displayed, and an operation panel 102 configured including plural keys through which various data and operation instructions are input.

The console 42 according to the present exemplary embodiment is equipped with: a CPU 104 that controls the operation of the device as a whole; a ROM 106 in which various programs, and the like, including a control program, are stored in advance; a RAM 108 that temporarily stores various data; an HDD 110 that stores and holds various data; a display driver 112 that controls the display of various data on the display 100; an operation input detection component 114 that detects the operational state of the operation panel 102; a communications interface (I/F) component 116, connected to the connection terminal 42A and transmitting and receiving various data to and from the radiation generation device 34 via the connection terminal 42A and the communications cable 35, such as later described radiation exposure conditions, and orientation data and status data of the radiation generation device 34; a wireless communications component 118 that transmits and receives various data, such as radiation exposure conditions and image data, to and from the electronic cassette 32 by wireless communication.

The CPU 104, the ROM 106, the RAM 108, the HDD 110, the display driver 112, the operation input detection component 114, the communications I/F component 116, and the wireless communications component 118, are mutually connected together by a system bus BUS. Consequently, the CPU 104 can access the ROM 106, the RAM 108 and the HDD 110, and the CPU 104 can control display of various data on the display 100 via the display driver 112, can control transmission and reception of various data to and from the radiation generation device 34 via the communications I/F component 116, and can control transmission and reception of various data to and from the electronic cassette 32 via the wireless communications component 118. The CPU 104 can also ascertain via the operation input detection component 114 the operational state of the operation panel 102 due to a user.

The radiation generation device 34 is equipped with: a radiation source 130 that outputs X-rays; a communications I/F component 132 that transmits and receives various data, such as radiation exposure conditions, and orientation data and status information of the radiation generation device 34, to and from the console 42; a radiation source control component 134 that controls the radiation source 130 based on received radiation exposure conditions; and a radiation source drive control component 136 that controls operation of the support and movement mechanism 52 by controlling power supply to various drive sources provided in the support and movement mechanism 52.

The radiation source control component 134 is also realized by a microcomputer and stores received radiation exposure conditions and orientation data. The radiation exposure conditions received from the console 42 include data such as tube voltage, tube current, irradiation duration, and the like, with the orientation data including data representing whether the imaging orientation is an upright position or a horizontal position. If the imaging orientation indicated by the received orientation data is an upright position then the radiation source control component 134 controls the support and movement mechanism 52 through the radiation source drive control component 136 such that the radiation source 130 is positioned in position 53A employed for upright image capture (see FIG. 2, a position in which the radiation emitted is irradiated from the side of a patient positioned in the imaging position 48). If the imaging orientation indicated by the received orientation data is a horizontal position then the radiation source control component 134 controls the support and movement mechanism 52 through the radiation source drive control component 136 such that the radiation source 130 is positioned in position 53B employed for horizontal image capture (see FIG. 2, a position in which the radiation emitted is irradiated from above a patient positioned in the imaging position 50). X-rays are irradiated from the radiation source 130 based on the received radiation exposure conditions.

Explanation will now be given of the operation of the Radiology Information System 10 according to the present exemplary embodiment.

The terminal device 12 (see FIG. 1) receives imaging requests, including environment information, from a doctor or radiologist. The imaging requests instruct the usage environment of the electronic cassette 32, the date and time of imaging and the imaging conditions (imaging location, angle and no. of frames, tube voltage, tube current and irradiation duration for carrying out radiation irradiation, and the size and sensitivity of the electronic cassette 32, and the like).

The terminal device 12 notifies the RIS server 14 of the contents of the received imaging request. The RIS server 14 stores the contents of the imaging request notified by the terminal device 12 in the database 14A.

The console 42 acquires, by accessing the RIS server 14, the contents of the imaging request from the RIS server 14 and displays the contents of the imaging request on the display 100.

The console 42 also transmits the orientation data, indicating the imaging orientation of the radiographic image due to be captured, to the radiation generation device 34. The radiation source control component 134 of the radiation generation device 34 controls the radiation source drive control component 136 such that the position of the radiation source 130 is in accordance with the imaging orientation instructed by the received orientation data.

The doctor or radiologist commences capturing the radiographic image based on the contents of the imaging request displayed on the display 100.

For example, as shown in FIG. 2, when a radiographic image is to be captured of an affected portion of a patient lying on the bed 46, the doctor or radiologist disposes the electronic cassette 32 between the bed 46 and affected portion of the patient, according to the imaging location and angle, with the radiation generation device 34 disposed above the affected portion. The doctor or radiologist then performs radiation exposure condition instruction operation on the operation panel 102 of the console 42, according to the imaging location on the patient and the imaging conditions, specifying the radiation exposure conditions of the tube voltage, tube current, and irradiation duration for X-ray irradiation. When the doctor or radiologist has completed radiation exposure preparation in the radiation generation device 34, imaging instruction operation is performed to the operation panel 102 of the console 42 to instruct imaging.

Explanation will now be given of details of the operation of the imaging system 18 according to the present exemplary embodiment.

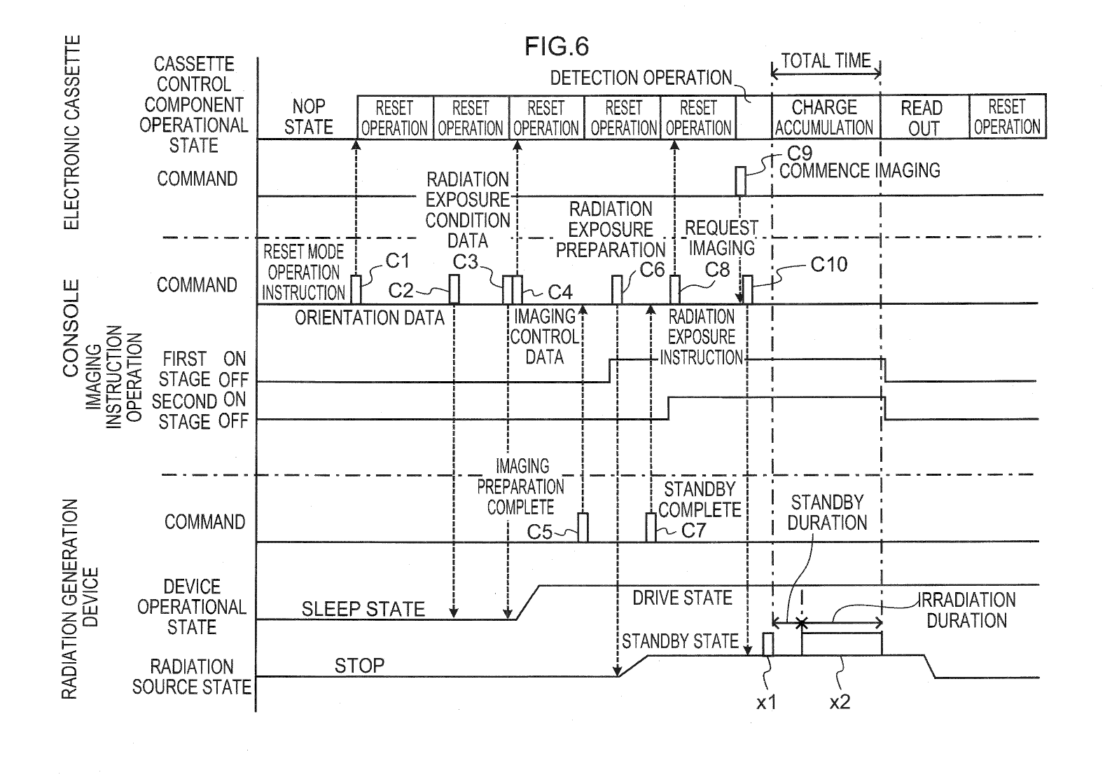

FIG. 6 shows a timing chart showing the operation flow when capturing a radiographic image using the imaging system 18 according to the first exemplary embodiment.

The operational mode of the electronic cassette 32 in the state when the power is switched on (state on start up) is the initial state of a non-operational state (NOP state), and the electronic cassette 32 is operated based on instruction data received by wireless communication from the console 42.

However, when the power of the electronic cassette 32 is switched on, the radiation detector 60 internally housed in the electronic cassette 32 (see FIG. 4) accumulates charge in each of the storage capacitors 68, due to dark current and the like, even in a state in which X-rays are not irradiated thereon. The cassette control component 92 therefore outputs an instruction signal instructing resetting to the signal processing component 82 when the operational mode is the non-operational state. When the signal processing component 82 is input with the instruction signal instructing resetting, the switch 84C (see FIG. 5) is switched on and both electrodes of the condenser 84B are shorted. The unwanted charge that has accumulated in the condenser 84B is discharged by shorting both electrodes of the condenser 84B in this manner.

When the console 42 is communicable with the electronic cassette 32, instruction data C1 instructing operation of the reset mode is transmitted to the electronic cassette 32 by wireless communication.

When the cassette control component 92 receives the instruction data C1 instructing operation of the reset mode, the operational mode progresses to the reset mode, and after a specific accumulation period has elapsed, the gate line driver 80 is controlled, and an ON signal is output from the gate line driver 80 in sequence one line at a time to each of the gate lines 76, and the TFT's connected to each of the gate lines 76 are switched on in sequence one line at a time and charge extraction is performed therefrom. Charge that has accumulated in each of the storage capacitors 68 thereby flows as an electrical signal out through each of the data lines 78 in sequence one line at a time. During periods in which the operational mode is the reset mode, after the accumulation period has elapsed the cassette control component 92 outputs the ON signal to each of the gate lines 76, in sequence one line at a time, and repeats the reset operation to reset one frame's worth by extracting charge accumulated in each of the respective pixel portions 74 of the radiation detector 60.

When capturing a radiographic image, the console 42 transmits orientation data C2 representing the imaging orientation during radiographic image capture to the radiation generation device 34.

When radiation exposure condition instruction operation has been performed to the operation panel 102, the console 42 transmits radiation exposure condition data C3, which is the tube voltage, tube current, irradiation duration, and the like that have been instructed by the radiation exposure condition instruction operation, to the radiation generation device 34 via the communications cable 35. When capturing a radiographic image, the console 42 transmits imaging control data C4, which is the irradiation duration for which radiation is to be irradiated from the radiation generation device 34 and the like, to the electronic cassette 32 by wireless communication.

In the radiation generation device 34, when the power has been switched on and a specific initialization operation has been completed, the radiation generation device 34 is on standby with an operational state of a sleep state. When in receipt of the above orientation data C2 the operational state progresses to the drive state and when in receipt of the radiation exposure condition data C3 the radiation generation device 34 stores the received radiation exposure conditions. When the operational state of the radiation generation device 34 has returned to the drive state and imaging preparations have been completed to image capture with the orientation instructed by the orientation data, data C5, indicating that imaging preparation is complete, is transmitted to the console 42 via the communications cable 35.

On receipt of the imaging control data C4 the cassette control component 92 of the electronic cassette 32 stores the received imaging control data.

On receipt of the data C5 indicating that imaging preparation is complete, the console 42 displays that imaging preparation is completed on the display 100, and imaging instruction operation of the operation panel 102, instructing imaging, is enabled. In the imaging system 18 according to the present exemplary embodiment, there are two stages of operation in the imaging instruction operation to the operation panel 102, and radiographic images are captured by performing the second stage of imaging instruction operation on the operation panel 102 after the first stage of imaging instruction operation has been performed. The two stages of imaging instruction operation may be, for example, by depressing two buttons of the operation panel 102 in sequence, or may be by partially depressing one button and then depressing it by the full amount.

When the first stage of imaging instruction operation is performed to the operation panel 102, the console 42 transmits instruction data C6 instructing radiation exposure preparation to the radiation generation device 34 via the communications cable 35.

When in receipt of the instruction data C6 instructing radiation exposure preparation, the radiation generation device 34 puts the radiation source 130 on standby to carry out radiation exposure with the tube voltage and tube current indicated in the radiation exposure conditions data stored just previously. When the radiation generation device 34 has completed putting the radiation source 130 on standby, the radiation generation device 34 transmits data C7 indicating standby completion to the console 42 via the communications cable 35.

On receipt of the data C7 indicating standby completion, the console 42 enables the second stage of imaging instruction operation. When the second stage of imaging instruction operation is performed to the operation panel 102, the console 42 transmits request data C8, requesting permission for irradiation of radiation for imaging, to the electronic cassette 32 by wireless communication.

When in receipt of the request data C8 requesting imaging, the cassette control component 92 performs a reset operation until one frame's worth of reset operation is complete, and when one frame's worth of reset operation has been completed the cassette control component 92 transmits instruction data C9, instructing imaging commencement, to the console 42 by wireless communication and the operational mode transitions to the imaging mode.

When in receipt of the instruction data C9 instructing imaging commencement, the console 42 transmits instruction data C10 instructing radiation exposure to the radiation generation device 34 via the communications cable 35.

When in receipt of the instruction data C10 instructing radiation exposure, the radiation source control component 134 of the radiation generation device 34, after a specific standby duration has elapsed from irradiation of radiation X1 for notifying radiation exposure commencement from the radiation source 130, irradiates radiation X2 for imaging from the radiation source 130 for the irradiation duration given in the radiation exposure conditions that were stored just previously.

The radiation X1, X2 irradiated from the radiation source 130 each reach the electronic cassette 32 after passing through the patient. Consequently, in order to suppress the radiation dose to the patient, the exposure of the radiation X1 for notifying radiation exposure commencement is preferably of a short irradiation duration within a range capable of notifying radiation exposure commencement.

After transmitting instruction data C9 instructing imaging commencement, the cassette control component 92 of the electronic cassette 32 performs detection operation and controls the gate line driver 80 such that an ON signal is output from the gate line driver 80, at intervals shorter than the reset operation duration, to each of the gate lines 76 in sequence one line at a time, and each of the TFT's connected to each of the gate lines 76 is switched ON in sequence one line at a time, extracting the charge therefrom. The electrical signals flowing out through each of the data lines 78 are input to the individual sample and hold circuits 84 and converted into voltage signals, the converted voltage signals are input in sequence into a multiplexer, converted into digital image data by the A/D convertor 88 and stored in the image memory 90. The cassette control component 92 detects the radiation X1 for notification based on the digital data stored in the image memory 90. Note that in detection operation, charge may be partially read out, by an ON signal being output from the gate line driver 80 in sequence to the gate lines 76 while skipping intervals of a specific number of lines, or an ON signal may be output only to plural of the gate lines 76 (for example two lines) in sequence from one end of the gate line driver 80 in the column direction.

When the radiation X1 for notification is detected, after elapse of the total time of the above standby duration added to the irradiation duration instructed in the radiation exposure conditions, the cassette control component 92 controls the gate line driver 80 so as to output from the gate line driver 80 an ON signal to each of the gate lines 76 in sequence one line at a time, and each of the TFT's 70 connected to the respective gate lines 76 are switched ON in sequence one line at a time.

In the radiation detector 60, when each of the TFT's 70 connected to the respective gate lines 76 are switched ON in sequence one line at a time, the charge that has been accumulated in each of the storage capacitors 68 flows out in sequence one line at a time through each of the data lines 78 as an electrical signal. The electrical signals flowing out through each of the data lines 78 are input into the individual sample and hold circuits 84 and converted into voltage signals, and the converted voltage signals are input in sequence (serially) to a multiplexer, converted into digital image data by the A/D convertor 88, and stored in the image memory 90.

After image capture, the cassette control component 92 transmits image data stored in the image memory 90 by wireless communication to the console 42.

In the console 42, image processing is performed on the received image data, the image processing performing various types of correction, such as shading correction and the like, and the image data after correction is stored in the HDD 110. The image data stored in the HDD 110 is displayed on the display 100, in order that the captured radiographic image can be checked and the like, and the image data is also transmitted to the RIS server 14 and stored in the RIS database. Displaying the captured radiographic image on the display of the terminal devices 12 in this manner enables a doctor to interpret the radiographic image, perform diagnosis or the like.

According to the present exemplary embodiment, when capturing a radiographic image, the radiation X1 for notification of radiation exposure commencement is irradiated from the radiation source 130 of the radiation generation device 34 prior to irradiating the radiation X2 for image capture, as described above. Forthcoming irradiation of the radiation X2 for image capture can be determined by detecting the radiation X1 for notification in the electronic cassette 32, and stable radiographic image capture can be performed. In addition, by temporarily ceasing radiation irradiation, from after irradiation of the radiation X1 for notification until commencing radiation of the radiation X2 for image capture, exposure dose to the patient can be suppressed.

Also, in the radiographic image imaging system 18 with wireless communication between the electronic cassette 32 and the console 42 as in the present exemplary embodiment, if the communication state becomes unstable and the instruction data C9 instructing imaging commencement transmitted from the electronic cassette 32 is delayed in transmission to the console 42, synchronization cannot take place between the electronic cassette 32 and console 42. However, by performing the irradiation of the radiation X1 as in the present exemplary embodiment, timing synchronization is readily made by the electronic cassette 32 starting reading out of the charge after the above total time described above has elapsed after detecting the radiation X1 for notification.

The electronic cassettes 32 are also portable, and so therefore are sometimes used in plural radiographic image imaging systems 18, and the standby duration, from irradiating the radiation X1 for notification up to irradiating the radiation X2 for image capture, may differ for each of the imaging systems, and the standby time may differ depending on the type of radiation source 130 and radiation generation device 34. In order to address this issue, for example, during a non-image capture period, such as calibration or the like, the radiation X2 for image capture may be irradiated from the radiation source 130 after elapse of a specific standby duration after the radiation X1 for notification has been irradiated from the radiation source 130, the standby duration measured by the cassette control component 92 detecting the standby duration from the detection of the radiation for notification up to the detection of the radiation for image capture, and this standby duration stored in the storage component 92C. When image capturing the control timing may then be varied so that commencement of read out of charge is undertaken after a total time has elapsed of the standby duration the cassette control component 92 has stored in the storage component 92C added to the irradiation duration. By so doing, stable radiographic image capture can be performed even when the standby duration is different. Furthermore, there is no need to notify the standby duration between the radiation generation device 34 and the electronic cassette 32.

### Second Exemplary Embodiment

Explanation now follows of a second exemplary embodiment of the present invention.

The configuration of the radiology information system 10, the imaging system 18, and the electronic cassette 32 according to the second exemplary embodiment are similar to those of the above first exemplary embodiment (see FIG. 1 to FIG. 5), and so explanation thereof is omitted.

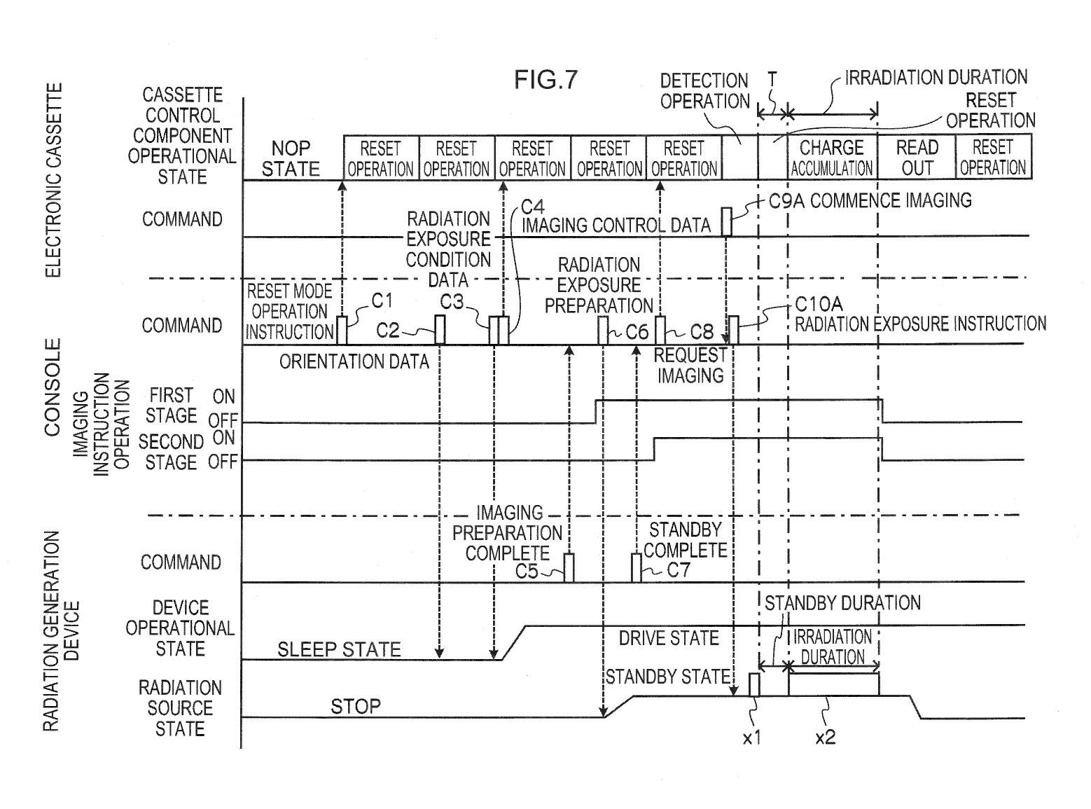

In FIG. 7, a timing chart is illustrated, showing the flow of operation when imaging a radiographic image with the imaging system 18 according to the second exemplary embodiment. Note that portions similar to those of the first exemplary embodiment (see FIG. 6) are allocated the same reference numerals and explanation thereof abbreviated, and portions that are different thereto are explained, allocated with the suffix “A”.

In the electronic cassette 32 according to the second exemplary embodiment, when radiation X1 for notification is detected, reset operation is performed to extract and remove charge accumulated in the sensor section due to the radiation X1. Furthermore, in order to shorten the operation period of the reset operation to remove charge accumulated due to the radiation X1, in the electronic cassette 32 according to the present exemplary embodiment, when radiation X1 for notification is detected, an ON signal is output from the gate line driver 80 to all of the gate lines 76 at the same time, then all of the TFT's 70 are switched ON by the gate lines 76, and one frame's worth of charge is extracted all at the same time.

When in receipt of the instruction data C8 requesting imaging, the cassette control component 92 performs reset operation until one frame's worth of reset operation has been completed. After one frame's worth of reset operation has been completed, the time T required to perform the reset operation a single time, extracting one frame's worth of charge all at the same time, is transmitted by wireless communication to the console 42, as a standby duration included in instruction data C9A instructing imaging commencement.

When in receipt of the instruction data C9A, the console 42 transmits the standby duration included in the instruction data C9A, via the communications cable 35, to the radiation generation device 34, included in instruction data C10A instructing radiation exposure.

When in receipt of the instruction data C10A, the radiation source control component 134 of the radiation generation device 34 irradiates radiation X1 for notifying radiation exposure commencement from the radiation source 130, after the standby duration included in the instruction data C10A has elapsed from irradiation of radiation X1, the radiation source control component 134 irradiates radiation X2 for imaging from the radiation source 130 for the irradiation duration given in the radiation exposure conditions that were stored just previously.

After transmitting the instruction data C9A, the cassette control component 92 of the electronic cassette 32, similarly to in the first exemplary embodiment, performs detection operation and controls the gate line driver 80 such that an ON signal is output from the gate line driver 80, at intervals shorter than the reset operation duration, to each of the gate lines 76 in sequence one line at a time. Then, when radiation X1 for notification is detected, the cassette control component 92 performs a reset operation, controlling the gate line driver 80 and outputting an ON signal from the gate line driver 80 to all of the gate lines 76 at the same time, with one frame's worth of charge being extracted all at the same time. After the reset operation, charge accumulation is commenced, and after elapse of the irradiation duration that was instructed in the radiation exposure conditions, from completion of the reset operation, the cassette control component 92 controls the gate line driver 80 so as to output from the gate line driver 80 an ON signal to each of the gate lines 76 in sequence one line at a time, and each of the TFT's 70 connected to the respective gate lines 76 are switched ON in sequence one line at a time.

In this manner, according to the present exemplary embodiment, after detecting the radiation X1 for notifying radiation exposure commencement, since the charge generated by the radiation X1 is removed by performing the reset operation, influence can be removed of the radiation X1, on the radiographic image imaged with the radiation X2 for imaging.

Furthermore, according to the present exemplary embodiment, by notifying the standby duration from the electronic cassette 32, the irradiation duration during which the radiation X2 for imaging is irradiated from the radiation source 130, and the accumulation period of charge in the electronic cassette 32, can be substantially matched to each other, and noise in the radiographic images occurring due to dark current and the like can be suppressed to a small amount.

Note that while explanation has been given in the above exemplary embodiments of a case where application is made to an electronic cassette as a portable radiographic image capture device, the present invention is not limited thereto, and application may also be made to a fixed radiographic image capture device.

Also, while explanation has been given in the above exemplary embodiments of a case in which the radiation detector 60 has a combined use as a detection component for detecting the radiation X1 for notification, the present invention is not limited thereto, and, for example, a radiation detection sensor may be provided as a different component to the radiation detector 60. Such a radiation detection sensor may be provided anywhere within the irradiation range of radiation irradiation from the radiation source 130.

In addition, explanation has been given in the above exemplary embodiment of a case where the radiation X1 for notification is irradiated a single time, however the present invention is not limited thereto, and, for example, the radiation X1 may be divided up and irradiated over a plural number of times.

Explanation has been given in the above exemplary embodiment of a case where the radiation source control component 134 of the radiation generation device 34 controls the radiation source 130 to cause exposure to be carried out, however the present invention is not limited thereto, and, for example, the CPU 104 of the console 42 may directly control the radiation source 130 so that exposure is carried out.

In addition, explanation has been given in the above exemplary embodiment of a case where the instruction data C10 instructing radiation exposure is transmitted from the console 42 to the radiation generation device 34, however the present invention is not limited thereto, and, for example, a wireless communication component may be provided to the radiation generation device 34 and the instruction data C10 instructing radiation exposure transmitted directly from the electronic cassette 32.

Furthermore, in the above second exemplary embodiment, explanation has been given of a case where, when radiation X1 for notification is detected, the cassette control component 92 controls the gate line driver 80 to output an ON signal from the gate line driver 80 to all of the gate lines 76 at the same time, and one frame's worth of charge is extracted all at the same time. However, the present invention is not limited thereto. For example, when the operation time of a reset operation that outputs an ON signal from the gate line driver 80 to each of the gate lines 76 in sequence one line at a time and extracts charge one line at a time, is sufficiently short, then when radiation X1 for notification is detected, the cassette control component 92 may perform such a reset operation that extracts charge one line at a time.

Furthermore, in the above first exemplary embodiment too, reset operation may be performed during the standby duration from when the radiation X1 was irradiated.

Also, while explanation has been given in the above exemplary embodiments of examples of the configuration of the radiology information system 10 (see FIG. 1), the configuration of the imaging system 18 (see FIG. 2 and FIG. 4) and the configuration of the electronic cassette 32 (see FIG. 3 and FIG. 5), obviously various changes thereto are possible according to the circumstance, within a range not departing from the spirit of the present invention.

Also, the operation flow when capturing radiographic images (see FIG. 6 and FIG. 7) that has been explained in the above exemplary embodiment is simply an example, and obviously various changes thereto are possible according to the circumstance, within a range not departing from the spirit of the present invention.

A first aspect of the present invention is a radiographic image capture system including: a radiation source control component that, when capturing a radiographic image, controls a radiation source such that radiation for image capture is irradiated after radiation for notification of radiation exposure commencement has been irradiated; a detection component that is provided within an irradiation range of radiation irradiated from the radiation source and that detects radiation irradiated from the radiation source; and a radiographic image capture device. The radiographic image capture device includes: a generation component having a sensor section with sensitivity to radiation and generating image data denoting a radiographic image representing radiation irradiated onto the sensor section; and an image capture control component that, when radiation for notification has been detected, controls the generation component such that a radiographic image is captured with the radiation for image capture irradiated after detection.

According to the first aspect of the present invention, the radiation source is controlled by the radiation source control component such that, when capturing a radiographic image, radiation for image capture is irradiated after radiation for notification of radiation exposure commencement has been irradiated, and radiation irradiated from the radiation source is detected by the detection component provided within the irradiation range of radiation irradiated from the radiation source.

According to the present invention, in the radiographic image capture device: image data denoting a radiographic image representing radiation irradiated onto the sensor section is generated by the generation component having the sensor section with sensitivity to radiation; and the generation component is controlled by the image capture control component such that a radiographic image is captured with the radiation for image capture irradiated after detection when radiation for notification has been detected by the detection component.

In this manner, according to the first aspect of the invention, stable capture of radiographic images can be performed while suppressing radiation exposure to an investigation subject. This is accomplished by controlling the radiation source, when capturing a radiographic image, such that radiation for image capture is irradiated after radiation for notification of radiation exposure commencement has been irradiated, and controlling the generation component such that a radiographic image is captured with the radiation for image capture irradiated after detection when radiation for notification has been detected in the radiographic image capture device.

In the present invention, the radiographic image capture device may be configured: to also include a transmission component that transmits by wireless communication an instruction to commence image capture after radiographic image capture preparation has been performed by the generation component; the radiation source control component provided either at a radiation generation device equipped with the radiation source or at an image capture control device that controls radiographic image capture, with the radiation generation device or the image capture control device enabled for wireless communication with the transmission component and further including a reception component that receives the instruction to commence image capture transmitted from the transmission component. In such a configuration, when the reception component has received the instruction to commence image capture, the radiation source control component commences radiation exposure of radiation for image capture; and the image capture control component, after the instruction to commence image capture has been transmitted from the transmission component, controls the generation component such that a radiographic image is captured of the radiation for image capture irradiated after detection when the radiation for notification has been detected by the detection component.

In the present invention, the radiographic image capture system may further include: a measuring component that, in a non-image capture period, measures a standby duration from detection by the detection component of radiation for notification until detection of radiation for image capture; and a storage component that stores the standby duration measured by the measuring component, wherein the image capture control component varies a control timing of the generation component based on the standby duration stored in the storage component.

In the present invention, preferably the sensor section and the detection component are the same component.

In the above aspect, preferably: charge is accumulated in the sensor section by irradiation of radiation thereon, and the generation component generates the image information denoting a radiographic image representing the irradiated radiation based on an amount of charge accumulated in the sensor section; and the image capture control component controls the generation component such that a reset operation is repeatedly performed extracting and removing charge accumulated in the sensor section in a non-image capture period, and the image capture control component sets the time interval between periods of extracting charge accumulated in the sensor section to be shorter than a reset operation duration when detecting radiation for notification in the sensor section.

In the above aspect, the image capture control component may perform partial extraction of charge in the sensor section when detecting radiation for notification in the sensor section.

In the above aspect, when the radiation for notification is detected in the sensor section, a reset operation of extracting and removing charge accumulated in the sensor section may be performed before the radiation for image capture is irradiated.

Further, the sensor section may be provided with a plurality of pixels in which charge is accumulated when the radiation is irradiated. Each of the pixels has a switching element for reading the accumulated charge, and with a plurality of gate lines for turning on and off the switching elements of the plurality of pixels. During the reset operation, the charge accumulated in the respective pixels may be all extracted at one time by outputting a signal for turning on the switching elements into each of the plurality of gate lines.

A second aspect of the present invention is a radiation generation device including: a radiation source capable of irradiating radiation; and a radiation source control component that, when capturing a radiographic image, controls the radiation source such that radiation for image capture is irradiated after radiation for notification of radiation exposure commencement has been irradiated.

According to the invention of the second aspect, the radiation source capable of irradiating radiation is controlled by the radiation source control component such that, when capturing a radiographic image, radiation for image capture is irradiated after radiation for notification of radiation exposure commencement has been irradiated.

Consequently, since the second aspect of the invention operates in a similar manner to the first aspect of the invention, stable capture of radiographic images can be performed while suppressing radiation exposure to an investigation subject.

A third aspect of the present invention is an image capture control device including: a radiation source control component that, when capturing a radiographic image, controls a radiation source such that radiation for image capture is irradiated after radiation for notification of radiation exposure commencement has been irradiated.

In the invention according to the third aspect, the radiation source is controlled by the radiation source control component such that, when capturing a radiographic image, radiation for image capture is irradiated after radiation for notification of radiation exposure commencement has been irradiated.

Consequently, since the third aspect of the invention operates in a similar manner to the first aspect of the invention, stable capture of radiographic images can be performed while suppressing radiation exposure to an investigation subject.

A fourth aspect of the present invention is a radiographic image capture device including: a generation component that has a sensor section with sensitivity to radiation, the generation component generating image data denoting a radiographic image representing the radiation irradiated onto the sensor section; a detection component, the detection component being provided within an irradiation range of radiation irradiated from a radiation source that irradiates radiation for image capture after radiation for notification of radiation exposure commencement has been irradiated, and the detection component detecting radiation irradiated from the radiation source; and an image capture control component that controls the generation component such that a radiographic image is captured with the radiation for image capture irradiated after detection when the radiation for notification has been detected by the detection component.

According to the fourth aspect of the invention: image data, denoting a radiographic image representing the radiation irradiated onto the sensor section, is generated by the generation having the sensor section with sensitivity to radiation; a detection component is provided within an irradiation range of radiation irradiated from a radiation source and the detection component detects radiation irradiated from the radiation source; and the generation component is controlled by the image capture control component such that a radiographic image is captured with the radiation for image capture irradiated after detection when the radiation for notification has been detected by the detection component.

Consequently, since the fourth aspect of the invention operates in a similar manner to the first aspect of the invention, stable capture of radiographic images can be performed while suppressing radiation exposure to an investigation subject.

According to the present invention, an effect is obtained in that stable capture of radiographic images can be performed while suppressing radiation exposure to an investigation subject.

What is claimed is:

1. A radiographic image capture system comprising:
a radiation source control component that, when capturing a radiographic image, controls a radiation source such that radiation for image capture is irradiated after radiation for notification of radiation exposure commencement has been irradiated;
a detection component that is provided within an irradiation range of radiation irradiated from the radiation source and that detects radiation irradiated from the radiation source; and
a radiographic image capture device that comprises:
a generation component that has a sensor section with sensitivity to radiation and that generates image information denoting a radiographic image represented by radiation irradiated onto the sensor section, and
an image capture control component that, when radiation for notification has been detected by the detection component, controls the generation component such that a radiographic image is captured with the radiation for image capture irradiated after detection.

2. The radiographic image capture system of claim 1, wherein:
the radiographic image capture device further comprises a transmission component that transmits by wireless communication an instruction to commence image capture at a time after radiographic image capture preparation has been performed by the generation component;
the radiation source control component is provided either at a radiation generation device equipped with the radiation source or at an image capture control device that controls radiographic image capture, the radiation generation device or the image capture control device enabled for wireless communication with the transmission component and further comprises a reception component that receives the instruction to commence image capture transmitted from the transmission component;
when the reception component has received the instruction to commence image capture, the radiation source control component commences radiation exposure of radiation for image capture; and
the image capture control component, after the instruction to commence image capture has been transmitted from the transmission component, controls the generation component such that a radiographic image is captured of the radiation for image capture irradiated after detection when the radiation for notification has been detected by the detection component.

3. The radiographic image capture system of claim 1 further comprising:
a measuring component that, in a non-image capture period, measures a standby duration from detection by the detection component of radiation for notification until detection of radiation for image capture; and
a storage component that stores the standby duration measured by the measuring component, wherein the image capture control component varies a control timing of the generation component based on the standby duration stored in the storage component.

4. The radiographic image capture system of claim 1, wherein the sensor section and the detection component are the same component.

5. The radiographic image capture system of claim 4, wherein:
charge is accumulated in the sensor section by irradiation of radiation thereon, and the generation component generates the image information denoting a radiographic image representing the irradiated radiation based on an amount of charge accumulated in the sensor section; and
the image capture control component controls the generation component such that a reset operation is repeatedly performed extracting and removing charge accumulated in the sensor section in a non-image capture period, and the image capture control component sets the time interval between periods of extracting charge accumulated in the sensor section to be shorter than a reset operation duration when detecting radiation for notification in the sensor section.

6. The radiographic image capture system of claim 4, wherein the image capture control component performs partial extraction of charge in the sensor section when detecting radiation for notification in the sensor section.

7. The radiographic image capture system of claim 1, wherein when the radiation for notification is detected in the sensor section, a reset operation of extracting and removing charge accumulated in the sensor section is performed before the radiation for image capture is irradiated.

8. The radiographic image capture system of claim 7, wherein:
the sensor section is provided with a plurality of pixels in which charge is accumulated when the radiation is irradiated, each of the pixels having a switching element for reading the accumulated charge, and with a plurality of gate lines for turning on and off the switching elements of the plurality of pixels; and
during the reset operation, the charge accumulated in the respective pixels is all extracted at one time by outputting a signal for turning on the switching elements into each of the plurality of gate lines.

9. A radiation generation device comprising:
a radiation source capable of irradiating radiation; and
a radiation source control component that, when capturing a radiographic image, controls the radiation source such that radiation for image capture is irradiated after radiation for notification of radiation exposure commencement has been irradiated.

10. An image capture control device comprising:
a radiation source control component that, when capturing a radiographic image, controls a radiation source such that radiation for image capture is irradiated after radiation for notification of radiation exposure commencement has been irradiated.

11. A radiographic image capture device comprising:
a generation component that has a sensor section with sensitivity to radiation, the generation component generating image data denoting a radiographic image representing the radiation irradiated onto the sensor section;
a detection component, the detection component being provided within an irradiation range of radiation irradiated from a radiation source that irradiates radiation for image capture after radiation for notification of radiation exposure commencement has been irradiated, and the detection component detecting radiation irradiated from the radiation source; and
an image capture control component that controls the generation component such that a radiographic image is captured with the radiation for image capture irradiated after detection when the radiation for notification has been detected by the detection component.

12. The radiographic image capture device of claim 11 further comprising a transmission component that transmits by wireless communication an instruction to commence image capture after image capture preparation has been made by the generation component.
